(19) United States
(12) Patent Application Publication
(10) Pub. No.: US 2015/0083341 A1
(43) Pub. Date: Mar. 26, 2015

(54) HEAT DETACHABLE ADHESIVE CONSTRUCTIONS, ARTICLES MADE THEREFROM AND METHOD OF USE THEREOF

(71) Applicant: 3M INNOVATIVE PROPERTIES COMPANY, St. Paul, MN (US)

(72) Inventors: Albert I. Everaerts, Oakdale, MN (US); Rusty J. Ferguson, Hugo, MN (US)

(73) Assignee: 3M INNOVATIVE PROPERTIES COMPANY, St. Paul, MN (US)

(21) Appl. No.: 14/036,915

(22) Filed: Sep. 25, 2013

(51) Int. Cl. B32B 43/00

(52) U.S. Cl. CPC B32B 43/006
USPC 156/711; 428/411.1

(57) ABSTRACT

An adhesive article includes a first substrate, a first adhesive layer positioned adjacent the first substrate, a second substrate, and a first meltable layer positioned adjacent to the first adhesive layer and the second substrate. The meltable layer has a ring and ball (R&B) softening point of between about 60° C. and about 180° C.

### TECHNICAL FIELD

The present invention relates generally to adhesive articles. In particular, the present invention relates to an adhesive article having at least one meltable layer that when heated, melts and allows adhered layers of the adhesive article to separate.

### BACKGROUND

Transfer tapes and foam tapes are used in numerous assembly applications. For example, transfer and foam tapes are used in industrial, automotive, aerospace, marine, construction, electronic device assembly, and other applications. The vast majority of transfer and foam tapes are used to permanently attach two substrates with high adhesion and high shear bond strength. However, in some circumstances there is also a need to detach the two substrates in a simple and effective manner. This detachment may be needed for rework during initial assembly, repair during field use of a product, or end-of-life disassembly and recycling of components. There is a particularly high need to securely attach the costly display components in smart phones, ultrabooks, and the like. As the displays get larger, thinner, and their components more fragile, the need to rework in a gentle and non-destructive way becomes even more critical.

### SUMMARY

In one embodiment, the present invention is an adhesive article including a first substrate, a first adhesive layer positioned adjacent the first substrate, a second substrate, and a first meltable layer positioned adjacent to the first adhesive layer and the second substrate. The meltable layer has a ring and ball (R&B) softening point of between about 60° C. and about 180° C.

In yet another embodiment, the present invention is a method of debonding a first substrate from a second substrate assembled together with an adhesive tape construction. The method includes providing an adhesive tape construction having an adhesive layer and a meltable layer, wherein the adhesive layer and the meltable layer are attached; heating the adhesive tape construction to a temperature above the R&B softening point of the meltable layer; and applying force on the substrates and thus between the adhesive layer and the meltable layer to trigger cohesive failure of the meltable layer. The R&B softening point of the meltable layer is between about 60° C. and about 180° C.

### BRIEF DESCRIPTION OF THE DRAWINGS

FIG. 1 is a cross-sectional view of a first embodiment of an adhesive article of the present invention.

FIG. 2 is a cross-sectional view of a second embodiment of an adhesive article of the present invention.

FIG. 3 is a cross-sectional view of a third embodiment of an adhesive article of the present invention.

FIG. 4 is a cross-sectional view of a fourth embodiment of an adhesive article of the present invention.

FIG. 5 is a cross-sectional view of a fifth embodiment of an adhesive article of the present invention.

FIG. 6a is a cross-sectional view of an adhesive article of the present invention.

FIG. 6b is a cross-sectional view of the adhesive article of FIG. 3 before debonding.

FIG. 6c is a cross-sectional view of the adhesive article shown in FIG. 6b after debonding.

These figures are not drawn to scale and are intended merely for illustrative purposes.

### DETAILED DESCRIPTION

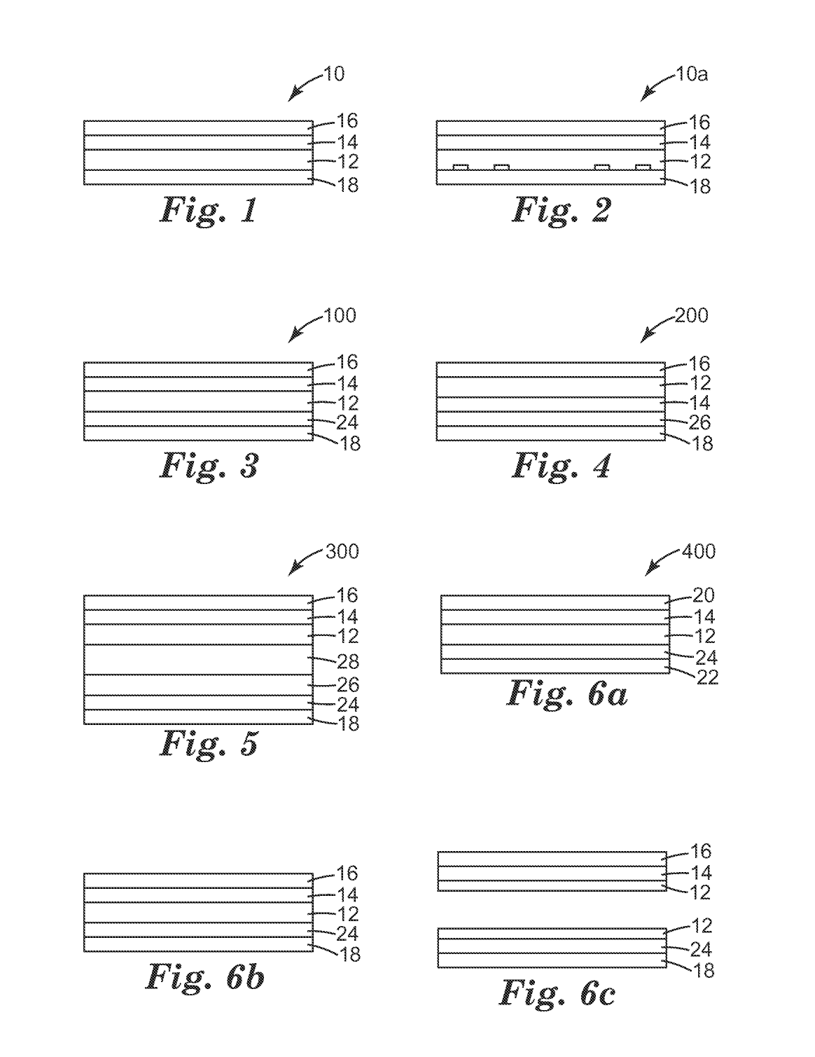

FIG. 1 shows a cross-sectional view of an embodiment of a heat-sensitive adhesive article 10 of the present invention. The adhesive article 10 includes a meltable, or melting, layer 12 positioned adjacent an adhesive layer 14. The meltable layer 12 and the adhesive layer 14 are positioned between a first substrate 16 and a second substrate 18. Although FIG. 1 discusses the melting layer 12 and the adhesive layer 14 as being positioned between two substrates, the melting layer 12 and the adhesive layer 14 may also be positioned between a substrate and a release liner or between two release liners. When heated, the meltable layer 12 of the adhesive article 10 melts/flows such that the first substrate 16 can be detached by shear, peel, or tensile load application from the second substrate 18. Articles assembled with an adhesive article 10 of the present invention are durable with high adhesion while still allowing for debonding at or above the designed Ring and Ball (R&B) softening point of the meltable layer 12, making the article easily reworkable. By incorporating a meltable layer 12 in the adhesive article 10, the disassembly process is greatly facilitated because once molten, the meltable layer 12 acts as a weak boundary material so that the adhesive article 10 can be split. “Molten” means real melting of a crystalline or semi-crystalline layer and/or passing through the glass transition temperature (Tg) of an amorphous layer, and having a melt strength that allows detachment of the substrates without mechanical damage to the substrates themselves (for example no breakage or permanent distortion). In many other debondable applications, such as those using stretch removal or heat-shrink film to trigger debonding, the adhesion to the substrates is limited and often low. In this case, adhesion to the substrates can be very high, yet the separation of the bonded substrates is still readily achieved.

The meltable layer 12 is a critical component in the construction of the heat-sensitive adhesive article 10. “Meltable” is defined as having a real crystalline melting point or a glass transition temperature, while also allowing sufficient softening and flow when exposed to temperatures above the melting point or glass transition temperature (Tg). The R&B softening point of the meltable layer is chosen so that it is high enough for the adhesive article 10 to be cohesively strong during normal use, but also low enough for the adhesive article 10 to be split when slightly heated at or above the R&B softening point of the meltable layer 12 in order to avoid thermal damage to the substrates to be recovered. For industrial applications, such as body panels in a car or appliances, relatively high softening points can be used, such as for example 100 to 180 degrees C. In more heat-sensitive applications, such as electronic display components, the upper melting temperature that can be accepted may be more limited, such as less than 120 degrees C. The meltable layer 12 has high adhesion to the adhesive layers of the adhesive article, and if used, to a film backing (shown in FIG. 5). If the meltable layer is in direct contact with the substrate, the layer will also have a durable bond with the substrate below the R&B softening point.

The meltable layer 12 melts or softens (i.e. if the melting layer is not crystalline but amorphous) sharply at the temperature desired for reworking or disassembly of the article. The meltable layer 12 should not soften prematurely to avoid creep (i.e. slow movement of bonded substrates relative to each other) in the adhesive article 10 at temperatures below the rework or disassembly temperature. The R&B softening point, or temperature, can be measured according to standard test methods, such as ASTMD36/36M−1 or ASTM E28-29. The R&B softening point can be interpreted as the temperature in which there is an onset of flow of the meltable layer 12. In one embodiment, the R&B softening point of the meltable layer 12 is about 180 degrees C. or less, particularly 120 degrees or less, and even more particularly about 100 degrees or less. In one embodiment, to be stable as a bonded product, the R&B softening point of the meltable layer 12 is about 60 degrees C. or more and particularly about 80 degrees C. or more. Once molten, the cohesive strength and viscosity of the meltable layer material should be low enough to allow for disassembly of the bonded article without excessive force. In order to facilitate detachment, the meltable layer 12 typically has a low to moderate melt index or melt viscosity. Melt viscosity and melt index are shear rate dependent, but during rework first one must overcome the initial resistance to flow to get the detachment of the substrates started. So, the zero shear rate viscosity can be used as another defining parameter for the melting layer materials of this invention. To facilitate the removal process, generally lower zero shear rates are favored over high zero shear rate viscosities. In essence, this zero shear rate viscosity is a value under static condition, similar to the R&B softening temperature, where the load is static. So, the R&B softening point or temperature can be used as a good measure to define the meltable layers of interest. Provided the initial inertia to movement can be overcome, more viscous melting layers with shear thinning character may be useful, but caution has to be taken to avoid too much resistance to onset of flow as this may cause mechanical damage to the substrates being detached. In one embodiment, the melt index at a temperature of 190° C. and a load of 2.16 Kg per ASTM D1238/ISO1133 of the meltable layer 12 is at least about 20 g/10 min, particularly at least about 100 g/10 min, and more particularly at least about 200 g/10 min. The cohesive strength of the meltable layer 12 can also be measured in the form of static shear strength. In one embodiment, at the melting temperature, the time to cohesive failure in a static shear test is less than 100 min when measured with a 1.56 cm² tape sample attached between two substrates and loaded with 1 kg weight. Preferably the time to failure is less than 10 minutes at or above the melting temperature.

In one embodiment of the heat sensitive adhesive article 10, the meltable layer 12 includes at least one meltable polymer or oligomer layer embedded between two adhesive layers. In one embodiment, the meltable layer 12 is a heat-sensitive backing or tie-layer. In one embodiment, the meltable layer 12 is crystalline, semi-crystalline, or amorphous. In one embodiment, the meltable layer 12 is optically clear. Typically optical clarity is defined as a material having less than 5% haze and greater than 90% transmittance of the visible light (400-700 nm wavelength). However, the meltable layer material itself does not have to be optically clear, even when used in an optically clear, heat-sensitive tape or sheet construction. In such cases, the meltable layer 12 is applied at a thickness of only a few microns so that a higher haze level or lower transmission for the meltable layer can be tolerated as long as it does not negatively affect the optical properties of the optically clear adhesive tape, sheet, or die cut (i.e. total tape construction is still optically clear). Thus semi-crystalline, or even crystalline meltable layer materials can be used, which when tested at 25 microns thickness or higher may not be considered optically clear.

The meltable layer 12 has a thickness that is sufficient to provide a cohesively weak layer and prevent direct contact between the adhesive layers when molten. In other words, in the molten state the meltable layer 12 can act as a lubricant between adhesive layers and prevent them from sticking together. In one embodiment, the meltable layer 12 is at least about one millimeter thick. In another embodiment, the layer is about a few microns thick or less. In one embodiment, the melting layer is less than about 5 mm thick, particularly less than about 1 mm thick, and more particularly less than about 0.50 mm thick. In one embodiment, the melting layer is at least about 1 micron thick, particularly at least about 10 microns thick, and more particularly at least about 20 microns thick.

In some constructions, the meltable layer 12 may be adjacent to a substrate with significant topography. FIG. 2, described below, shows such an article and substrate. Additional examples of such substrates include, for example, lenses with an ink border, touch sensors with attached flexible connector, and optical films for light management, such as micro-lenslets for a 3D display. In such cases, the thickness of the meltable layer 12 may have to be sufficient to allow it to completely fill in the topography of the substrate during the assembly process. This may require the meltable layer 12 to have a thickness that is at least similar to the height of the tallest features in the topography of the substrate. The thickness of the meltable layer 12 may also be limited by the manufacturing process. For example, hot melt processes may allow for thicker coatings to be applied, while solvent coating processes may be more suitable for meltable layer 12 thicknesses of less than about 75 microns. Solvent casting may be preferred for thin meltable layer coatings on the order of a few microns. Hot melt extrusion of a film, followed by a tentering operation (stretching of a film in uniaxial or biaxial mode at elevated temperature) may also allow for thin meltable layers to be generated. As mentioned above, the meltable layer material itself may not always be optically clear, yet in a final optically clear product or assembly it may be desirable to be low in haze and low in color. Thus, in those cases a very thin layer of an otherwise hazy meltable layer 12 can still be useful. For non-optical uses, haze and color can often be tolerated. Likewise, if the final article needs to be opaque or colored, it may be advantageous to apply a thicker meltable layer 12 in the article 10, as thicker layers can enhance the optical effect. Depending on the desired thickness of the meltable layer 12, the meltable layer 12 may be hot melt extruded, melt pressed, calendared or solvent cast. This can be done on a release liner or directly on one of the adhesive layers used in the final heat-sensitive adhesive article 10. The second adhesive layer can then be laminated or cast onto this construction to make the final tape. If the meltable layer 12 is deposited on a release liner, both adhesive layers can be laminated to the meltable layer to make the final adhesive article.

The meltable layer 12 can be physically or ionically crosslinked and typically has low to moderate molecular weight in order to be meltable and maintain low melt viscosities. Unlike physical or ionic crosslinking, which can be thermally reversed, covalent crosslinking, is not thermally reversible and thus it can only be used to crosslink the melting layer material after the bonding process is completed and removal of the substrates is no longer required. In one embodiment, a low molecular weight is considered to be about 50,000 Daltons or less as measured by GPC (against a polystyrene standard) and a moderate molecular weight is considered to be between 50,000 Daltons and about 500,000 Daltons. A low to moderate molecular weight also minimizes the forces that make the meltable layer 12 fail cohesively in the molten state. Physical crosslinking can result from, for example: hydrogen bonding, acid-base interactions, ionic crosslinking, phase separation of hard segments (such as from polystyrene or polymethylmethacrylate macromers used in graft copolymers), high Tg (i.e. polystyrene or polymethylmethacrylate) blocks in blockcopolymers, urethane hard segments. etc.), crystalline segments (i.e. packed linear, long alkyl acrylate groups like behenyl in an acrylate copolymer, the regular backbone of a Nylon, etc.), and the like. Once this physical interaction is weakened by heating, the use of shear or cleavage force will induce cohesive failure of the meltable layer.

Examples of suitable physically crosslinked materials include, but are not limited to polyamides, polyesters, polyurethanes, ethylene copolymers, such as ethylene-vinyl acetate or ethylene-butylacrylate, polyalkyleneoxides, and the like. Side-chain crystalline acrylate copolymers (such as those disclosed in US 2006/0099372A1, herein incorporated by reference), macromer containing and acrylate graft copolymers can also be used. Other useful materials include, but are not limited to, (meth)acrylate functional polymers, wherein such functional groups are terminal or pendant groups on a backbone derived from a polyester, epoxy, or polyurethane, for example. These types of polymers have the additional benefit of being UV curable when compounded with a photoinitiator. Thus, melting and flow of the polymers can be stopped if a UV transparent substrate is bonded, the layer is cured, and the assembly is final. There is therefore no longer need to rework the assembly. Examples of (meth)acrylate functional acrylate polymers can be found in U.S. application Ser. No. 13/832,457, which is herein incorporated by reference. Ionomerically crosslinked polymers such as those disclosed in U.S. Pat. No. 6,720,387, and acrylic blockcopolymers such as those disclosed in U.S. Pat. No. 6,806,320 can also be used. Both U.S. Pat. Nos. 6,720,387 and 6,806,320 are herein incorporated by reference. Polymer modified nanoparticles, such as those disclosed in U.S. application Ser. No. 13/832,457, can also be used.

Somewhat surprisingly, even a thin tackifier layer can be used as the meltable layer 12, although in some cases such layer may be brittle and thus easily fractured. A combination of tackifiers and polymers may make the layer less fragile and allow the onset of flow to be tuned.

Any adhesive may be used as an adhesive layer of the adhesive article 10 that has high adhesiveness to the meltable layer 12 and that forms a durable bond line between substrates 16 and 18 that are bonded using the adhesive article 10. The adhesive layer 14 of the adhesive article 10 can be selected from any type of adhesive, including, for example: pressure-sensitive adhesives, heat-activated adhesives, semi-structural adhesives and structural adhesives. In one embodiment, the adhesive layer 14 is optically clear. Optical clarity is defined as less than 5% haze and greater than 90% transmittance in the visible light range (400 nm to 700 nm wavelength). For example, in the case of display assemblies, the adhesive layer 14 is optically clear when used in the viewing area, such as in the format of an adhesive filling the air gap between a lens and touch panel, lens and display (i.e. LCD or OLED), or both. In other embodiments, the adhesive layer 14 does not have to be optically clear, such as when the adhesive assembly is outside of the viewing area of a display device or in industrial type applications. In this case, the adhesive layer 14 can be opaque or colored.

When substrates 16 and 18 are release liners 20 and 22 (shown for example in FIG. 6a), they function to keep the adhesive layer 14 free of dirt and debris until the adhesive article 10 is ready for use. When the adhesive article 10 is to be used to adhere two substrates together, the release liners are removed and the substrates are positioned respectively adjacent the exposed adhesive layer 14 and meltable layer 12.

In addition to the debonding, the adhesive article of the present invention also enables repositioning of two bonded substrates without having to break the adhesive bond. For example, in the case of an electronic 3D display assembly, the alignment of the lenslet arrays is critical, but also very difficult. By bonding the substrates with an optically clear version of the adhesive article 10 of the present invention, it is possible to heat the 3D display assembly slightly above the R&B softening point of the meltable layer 12, reposition the substrates 16 and 18 relative to each other with a sliding motion, and cool the assembly below the R&B softening point of the meltable layer 12 to lock the relative positions of the substrates in place. If desired, the meltable layer 12 can then be covalently crosslinked by, for example, an ultraviolet light (UV) triggered process to permanently lock the substrates in place relative to one another. Thermosetting crosslinking mechanisms may also be employed. In this case, the thermosetting crosslinking may initiate at a significantly higher temperature than the R&B softening point or may be designed to have an appreciable cure delay time at the R&B softening point, in order to allow sufficient time to reposition or separate the substrates. In this type of application, it may be desirable to have a meltable layer 12 with a low melt viscosity and limited polymer entanglement to avoid shear induced stress and/or orientation induced birefringence during repositioning.

A specific example of an adhesive article in use is shown in the adhesive article 10a depicted in FIG. 2 in which a meltable layer is used to adhere a first substrate 16, a display lens, and a second substrate 18, an indium tin oxide (ITO) coated sensor. In the embodiment of FIG. 2, the melting layer 12 also functions as a protective and/or high refractive index layer that is applied against an ITO coated touch sensor. The meltable layer 12 can encapsulate the ITO traces while also bonding the adhesive layer 14 to the trace. In some cases, the adhesive layer 14 may be positioned against the ITO sensor, while the melting layer 12 is facing the other substrate (for example a display lens). These constructions can be reworked by the same process discussed above.

The adhesive article of the present invention can include various structures with varying layers of adhesive layers and meltable layers. In an embodiment shown in FIG. 3, the adhesive article 100 includes a first substrate 16, a first adhesive layer 14, a meltable layer 12, a second adhesive layer 24 and a second substrate 18. In the adhesive article 100, the meltable layer 12 is positioned between the adhesive layers 14 and 24. In yet another embodiment shown in FIG. 4, the adhesive article 200 includes a first substrate 16, a meltable layer 12, an adhesive layer 14, a second meltable layer 26 and a second substrate 18. The first and second meltable layer may have dissimilar materials, they may be the same materials with different thickness, or both. In some cases, the first and second meltable layer be the same material and/or may have the same layer thickness. In the adhesive article 200, the adhesive layer 14 is positioned between the meltable layers 12 and 26.

FIG. 5 shows a cross-sectional view of an embodiment of an adhesive article 300 of the present invention. The adhesive article 300 of FIG. 5 includes a first substrate 16, a first adhesive layer 14, a first meltable layer 12, a film backing 28, a second meltable layer 26, a second adhesive layer 24 and a second substrate 18. The meltable layers 12 and 26 are positioned between adhesive layers 14 and 24. Although the embodiment shown in FIG. 5 depicts two meltable layers 12 and 26, any number of meltable layers may be included in the adhesive article 300. The film backing 28 is positioned between the meltable layers 12 and 26 to aid in handling of the adhesive article during assembly or disassembly. In another embodiment, the film backing 28 may be positioned adjacent to only one meltable layer. The film backing 28 may be used for just mechanical reinforcement or may also be used to aid in the debonding process. The film backing 28 can be used as a heat-shrinkable backing that is triggered at, below, or even slightly above the R&B softening temperature of the meltable layers 12 and 26, introducing a shear load on the meltable layers 12 and 26. The film backing 28 can also be used as a thermo-morphic or shape-memory layer which may expand in the z-direction of adhesive article, thus exercising a tensile load on the adhesive article 300. In this use, the trigger temperature for the shape to change would be at, below, or even slightly above the R&B softening point of the meltable layers 12 and 26. The film backing 28 may also be energy receptive and can be locally heated to transfer the heat to at least one of the meltable layer(s) 12 and 26. Examples of such energy receptive film backing may be those made by inclusion of, for example, near infrared (NIR) dyes and microwave susceptible compounds or particles, particles that are heated with inductive coupling, etc. Optionally, the energy receptors may be included in at least one of the meltable layers 12 and 26 itself as well, but using the film backing 28 as the energy absorber and heat generator for at least one of the meltable layers 12 and 26 may be advantageous if the meltable layer 12 and/or 26 is very thin (i.e. only a few (i.e. <10) microns thick, too thin to encapsulate the particles or provides little path length for NIR absorption). In the case of an electronic assembly using an adhesive article of the present invention, the film backing 28 may also have an electrical, barrier, or optical function. An example of an electrical function would be a touch sensor, such as dual side ITO coated film sensor. An example of a barrier function may be a moisture barrier in an electro-phoretic display. An example of an optical function may be a polarizer.

FIGS. 6a, 6b and 6c show cross-sectional views of an adhesive article 400 of the present invention during debonding. FIG. 6a shows a cross-sectional view of an adhesive article 400 of the present invention including a meltable layer 12 positioned between a first adhesive layer 14 and a second adhesive layer 24. A first release liner 20 is positioned adjacent the first adhesive layer 14 and a second release liner 22 is positioned adjacent the second adhesive layer 24 in order to keep the adhesive layers 14 and 24 free of dirt and debris until the adhesive article 400 is ready for use. FIG. 6b shows the adhesive article after the release liners 20 and 22 have been removed from the adhesive layers 14 and 24 and the adhesive article is being used to attach a first substrate 16 to a second substrate 18. The first substrate 16 is adhered to the first adhesive layer 14 while the second substrate 18 is adhered to the second adhesive layer 24. When the first substrate 16 and the second substrate 18 are to be separated, heat is first applied to the adhesive article 400 to melt the meltable layer 12. The meltable layer 12 is cohesively strong at normal use conditions but becomes cohesively weak at elevated temperatures due to the break-up of the physical crosslinking or entanglement of the material. Shear, peel or tensile load is then applied at the meltable layer 12 in order to split the meltable layer 12, as shown in FIG. 6c. When exposed to shear, peel, or tensile load at elevated temperatures, the meltable layer 12 fails and splits cohesively, allowing the first and second substrates x and y that were bonded with the adhesive article 400 to be separated. Residue from the meltable layer 12 may be left on the adhesive layers 14 and 24 of the now split adhesive article 400, but the adhesive layers 14 and 24 are readily accessible and can be removed from the individual substrates by peeling, stretch-release or any other acceptable removal method. Peeling removal of the adhesive layers 14 and 24 possibly covered with residue from the meltable layer 12 can for example be facilitated by applying a sticky adhesive tape to the surface of the adhesive layer 14, 24 (or the residue of meltable layer 12) or by simply heat bonding a film backing to the residue of the meltable layer 12 and peeling after the meltable layer 12 residue cools and regains cohesive strength. Rubbing with a cleaning substrate, in the presence of an appropriate solvent, may also be used to remove adhesive residue.

The adhesives articles of the present invention can be used in typical display articles, such as those used in mobile handheld devices, computers, televisions, and active signage displays. In these devices, it may be beneficial to recover expensive components either immediately after assembly if the device fails inspection, or during repair or recycling of the device after the device has been put into use. The display articles can be constructed in several ways, but the heat-sensitive adhesive article is generally directly attached to the substrate that needs to be recovered. For example, a lens may be attached to an LCD panel using the adhesive article of the present invention. In another example, the lens may be bonded to a touch panel, which may also be bonded to an LCD. The heat-sensitive adhesive article may be used to respectively bond the lens to the touch panel and the touch panel to the LCD, or both. In each case, the heat-sensitive adhesive article is positioned in the display stack in such a way that after heating and debonding, the substrate of interest can be recovered. In many cases, the display unit, LCD or OLED will be this substrate, although in some cases the touch sensor or lens may also need to be recovered.

In addition to the display assembly industry, the heat-sensitive adhesive article may also be used in the industrial, automotive, construction, marine, and aerospace markets. In such cases, the heat-sensitive adhesive article can be used for durable assembly of panels. For example, the substrates may include, but are not limited to: a painted metal panel, a bar metal panel, a molding, a plastic panel or a window glass. By incorporating a meltable layer in the tape construction and selecting a melting temperature above the service temperature of the assembly, a durable bond can be obtained. However, when the meltable layer is heated to the point that it abruptly becomes cohesively weak, the assembly can be taken apart. This can be particularly advantageous for repair or recycling of parts.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

### Materials

Materials

| Abbreviation | |
|---|---|
| or Trade | |
| Name | Description |
| OCA8182 | An optically clear, acrylic, laminating adhesive, available |
| | under the trade designation “3M OPTICALLY CLEAR |
| | ADHESIVE 8182” from 3M Company, St. Paul, |
| | Minnesota. |
| UAF472 | A polyurethane adhesive film, available under the trade |
| | designation “UAF472” from Adhesive Films, Inc., Pine |
| | Brook, New Jersey. |
| UAF438 | A polyurethane adhesive film, available under the trade |
| | designation “UAF438” from Adhesive Films, Inc., Pine |
| | Brook, New Jersey. |
| LA410 | An acrylic block copolymer, available under the trade |
| | designation “LA 410” from Kuraray Co., Ltd., Tokyo, |
| | Japan. |
| Foral 85E | A thermoplastic ester resin derived from glycerol and a |
| | highly stabilized rosin, available under the trade designation |
| | “FORAL 85-E ESTER OF A HYDROGENTED ROSIN” |
| | from Eastman Chemical Company, Kingsport, Tennessee. |
| Rez 1094 | A hydrocarbon resin, available under the trade designation |
| | “REGALREZ 1094 HYDROCARBON RESIN”, from |
| | Eastman Chemical Company. |
| Elvax 410 | Ethylene-vinyl acetate copolymer resin having a melt index |
| | of 500 g/10 min, available under the trade designation |
| | “DUPONT ELVAX 410” from E.I. du Pont du Nemours |
| | and Company, Inc., Wilmington, Delaware. |
| Elvax 205W | Ethylene-vinyl acetate copolymer resin having a melt index |
| | of 800 g/10 min, available under the trade designation |
| | “DUPONT ELVAX 205W” from E.I. du Pont du Nemours |
| | and Company, Inc. |
| Elvax 150 | Ethylene-vinyl acetate copolymer resin having a melt index |
| | of 43 g/10 min, available under the trade designation |
| | “DUPONT ELVAX 150” from E.I. du Pont du Nemours |
| | and Company, Inc. |
| Elvax 360 | Ethylene-vinyl acetate copolymer resin having a melt index |
| | of 2 g/10 min, available under the trade designation |
| | “DUPONT ELVAX 360” from E.I. du Pont du Nemours |
| | and Company, Inc. |
| Elvax 265 | Ethylene-vinyl acetate copolymer resin having a melt index |
| | of 3 g/10 min, available under the trade designation |
| | “DUPONT ELVAX 265” from E.I. du Pont du Nemours |
| | and Company, Inc. |

### Test Methods and Preparation Procedures

### Shear Deformation Test

The adhesive articles, which include a meltable layer positioned between two adhesive layers, were cut into sheets about 2 inch (5.1 cm)×3 inch (7.6 cm). The sheets were used to vacuum laminate two—2 inch (5.1 cm)×3 inch (7.6 cm) glass panels together using a Takatori vacuum laminator (available from Takatori Corporation, Kashihara, Japan). Lamination of the assembly was conducted at 40° C., a vacuum of 100 Pa and a pressure on the panel of about 40 N/cm² for 10 seconds. The glass laminates were then positioned on an electrical, ceramic hot plate, which was adjusted to different temperature settings. The temperature of the hot plate was monitored using a non-contact, infrared thermometer, model number IR-60CFO, available under the trade designation SCOTCHTRAK INFRARED HEAT TRACER (from 3M Company, St. Paul, Minn.). During use, the temperature of the hot plate cycled about 5° around the average temperature recorded, as shown in Table 1. After about one minute of heating, it was assumed that the adhesive article temperature was the same as the recorded average temperature and uniform throughout the article, and a shear force was applied to the glass panel laminates by hand. The average temperature at which the glass substrates started sliding relative to each other and detached was recorded. “Passing” meant that the glass panel laminate separated into the two individual glass panels (with some adhesive residue on both), failing meant that the glass laminate did not come apart or required excessive force to come apart. In some cases, the glass panels readily separated from each other (shown in Table 1 as “pass, low force”). In some cases, the glass panels required a moderate force to separate (shown in Table 1 as “pass, moderate force”). In other cases, the panels came apart at the recorded temperature but, required a significantly higher shear force (shown in Table 1 as “pass, high force”). However, for these panels that passed, there was no risk of the glass breaking. A temperature of 130° C. was chosen as the upper limit for this test to “pass”, because the substrates for the target application, e.g. a display panel, would be damaged at higher temperatures. For less temperature sensitive substrates, slightly higher temperatures may be tolerated and laminated panels shown as “pass, moderate force” and “pass, high force” could be more readily separated with less force. Results of the shear deformation test are shown in Table 1. For two comparative examples, CE11 and CE12, two layers of the same adhesive were laminated together (without a meltable layer) and were then used to laminate the two glass panels together.

### Softening Point Temperature

The softening point of the meltable layers is determined using a ring and ball test method according to ASTM E28-99. Reported values in Table 1 were available from the supplier in corresponding trade literature.

### Melt Index

The melt index values of Elvax 410, Elvax 205W, Elvax 150, Elvax 360 and Elvax 265 were available from the supplier (measured according to ASTM D1238/1501133 at a temperature of 190° C. and a load of 2.16 Kg).

### Preparation of Polymers

Polymer 1: Polymer 1 was made according the general procedure described in U.S. Pat. No. 5,986,011 (Ellis) using the following monomer charges in parts by weight: 50/30/15/5 n-butylmethacrylate/2-ethylhexylacrylate/2-hydroxyethylacrylate/acrylamide. The weight average molecular weight, determined by GPC in tetrahydrofuran using polystyrene standards, was 171 kiloDalton.

Polymer 2: Polymer 2 was made following the same procedure described for Polymer 1 except the monomer charge was 90/10 parts by weight isooctylacrylate/acrylic acid. The weight average molecular weight, determined by GPC in tetrahydrofuran using polystyrene standards, was 290 kiloDalton.

### Preparation of Optically Clear Adhesive 1 (OCA-1)

A monomer premix was prepared, on a weight basis, using 69 parts 2-ethylhexyl acrylate, 12 parts diacetone acrylamide, 19 parts 2-hydroxyethyl acrylate, and 0.02 parts 2,2-dimethoxy-2-phenylacetophenone photoinitiator (trade designation Irgacure 651, available from BASF Corporation, Florham Park, N.J.). This mixture was partially polymerized under a nitrogen-rich atmosphere by exposure to ultraviolet radiation yielding a syrup having a viscosity of about 1,000 cps. Following the polymerization, 0.20 parts of 2,2-dimethoxy-2-phenylacetophenone photoinitiator, 0.075 parts of 1,6-hexanediol diacrylate, and 0.25 parts of pentaerythritol tetrakis (3-mercaptobutyrate) (available from Showa Denko, Tokyo, Japan) were added to the syrup. The syrup was then knife coated onto a silicone-treated polyethylene terephthalate (PET) release liner at a coating thickness of 8 mils (200 microns). A second PET release liner was laminated to the exposed surface of the coating. The resulting PET liner/syrup/PET liner laminate was then exposed to ultraviolet radiation having a spectral output from 300-400 nm with a maximum at 351 nm, the total energy exposure was 1,600 mJ/cm², yielding OCA-1.

### Melting Layer Film Preparation

As indicated in Table 1, films of the meltable layer were prepared by a conventional solvent casting technique, melt pressing using a conventional heated press, or were used “as received” from the supplier (already coated on a release liner). The meltable layer thickness of the solvent cast, melt pressed or as received film is shown in Table 1.

### Examples 1-10 and Comparative Examples CE11-CE14

Using a hand roller, adhesive articles were prepared by dry laminating, at room temperature, a first adhesive layer to a first major surface of the melting film and a second adhesive layer to the second major surface of the meltable layer. The meltable layer and adhesive layers are specified in Table 1. In Table 1, CE11 designates Comparative Example 11, CE12 designates Comparative Example 12, CE13 designates Comparative Example 13 and CE14 designates Comparative Example 14.

TABLE 1

| | | | | | Meltable | | | Softening |
|---|---|---|---|---|---|---|---|---|
| | | Meltable | First | Second | Layer | Hot Plate | Shear | Point |
| | Meltable | layer | Adhesive | Adhesive | Thickness | Set Temp. | deformation | Temp. |
| Ex. | Layer | preparation | Layer | Layer | (micron) | (° C.) | test | (° C.) |
| 1 | UAF472 | As | OCA-1 | OCA-1 | 25 | 110 | Pass, high | — |
| | | received | | | | | force | |
| 2 | UAF438 | As | OCA-1 | OCA-1 | 25 | 110 | Pass, high | — |
| | | received | | | | | force | |
| 3 | LA410 | Melt | OCA8182 | OCA8182 | 25 | 110 | Pass, high | — |
| | | pressed | | | | | force | |
| 4 | Polymer 1 | Solvent | OCA8182 | OCA8182 | 25 | 90 | Pass, | — |
| | | cast | | | | | moderate | |
| | | | | | | | force | |
| 5 | Foral 85E | Solvent | OCA8182 | OCA8182 | 10 | 90 | Pass, low | 85 |
| | | cast | | | | | force | |
| 6 | Rez 1094 | Solvent | OCA8182 | OCA8182 | 10 | 90 | Pass, low | 95 |
| | | cast | | | | | force | |
| 7 | Polymer 2 | Solvent | OCA8182 | OCA8182 | 25 | 100 | Pass, high | — |
| | | cast | | | | | force | |
| 8 | Elvax 410 | Melt | OCA8182 | OCA8182 | 25 | 90 | Pass, low | 88 |
| | | pressed | | | | | force | |
| 9 | Elvax 205W | Melt | OCA8182 | OCA8182 | 25 | 90 | Pass, low | 80 |
| | | pressed | | | | | force | |
| 10 | Elvax 150 | Melt | OCA8182 | OCA8182 | 25 | 120 | Pass, | 110 |
| | | pressed | | | | | moderate | |
| | | | | | | | force | |
| CE11 | None | — | OCA8182 | OCA8182 | — | 130 | Fail | — |
| CE12 | None | — | OCA-1 | OCA-1 | — | 130 | Fail | — |
| CE13 | Elvax 360 | Melt | OCA8182 | OCA8182 | 25 | 130 | Fail | 188 |
| | | pressed | | | | | | |
| CE14 | Elvax 265 | Melt | OCA8182 | OCA8182 | 25 | 130 | Fail | 171 |
| | | pressed | | | | | | |

The data of Table 1 indicate that the adhesive articles of Examples 1-10, which included a meltable layer positioned between a first adhesive layer and a second adhesive layer, all passed the Shear Deformation Test. Additionally, adhesive articles which included a meltable layer having a softening point temperature from about 85° C. to 110° C. all passed the Shear Deformation Test. Adhesive articles that did not contain a meltable layer (CE11 and CE12) or include a meltable layer having a high softening point temperature (CE13 and CE14) failed the Shear Deformation Test.

Although the present invention has been described with reference to preferred embodiments, workers skilled in the art will recognize that changes may be made in form and detail without departing from the spirit and scope of the invention.

What is claimed is:

1. An adhesive article comprising:
a first substrate;
a first adhesive layer positioned adjacent the first substrate;
a second substrate; and
a first meltable layer positioned adjacent to the first adhesive layer and the second substrate, wherein the meltable layer has a ring and ball (R&B) softening point of between about 60° C. and about 180° C.

2. The adhesive article of claim 1, further comprising a second adhesive layer, wherein the first meltable layer is positioned between the first adhesive layer and the second adhesive layer.

3. The adhesive article of claim 2, further comprising a second meltable layer, wherein the second meltable layer is positioned between the first adhesive layer and the second adhesive layer.

4. The adhesive article of claim 3, further comprising a film layer.

5. The adhesive article of claim 1, further comprising a second meltable layer, wherein the first adhesive layer is positioned between the first meltable layer and the second meltable layer

6. The adhesive article of claim 1, wherein the R&B softening point of the first meltable layer is between about 60° C. and about 120° C.

7. The adhesive tape of claim 1, wherein the R&B softening point of the first meltable layer is between about 80° C. and about 100° C.

8. The adhesive article of claim 1, wherein the meltable layer at melt temperature fails a static shear test in less than 100 minutes measured with a 1.56 cm² tape sample attached between two substrates and loaded with 1 kg weight.

9. The adhesive article of claim 1, wherein the first meltable layer is positioned adjacent an ITO trace.

10. The adhesive article of claim 1, wherein the substrates are one of a release liner, display lens, LCD lens, touch sensor, optical film, painted metal panel, bar metal panel, molding, plastic panel and window glass.

11. A method of debonding a first substrate form a second substrate, wherein the first substrate and the second substrate are assembled together with an adhesive tape construction, the method comprising:
providing an adhesive tape construction having an adhesive layer and a meltable layer, wherein the adhesive layer and the meltable layer are attached;
heating the adhesive tape construction to a temperature to or above a R&B softening point of the meltable layer; and
applying force between the first and second substrates and the adhesive layer and the meltable layer to trigger cohesive failure of the heat sensitive layer,
wherein the R&B softening point of the meltable layer is between about 60° C. and about 180° C.

12. The method of claim 11, wherein the R&B softening point of the meltable layer is between about 60° C. and about 120° C.

13. The method of claim 11, wherein the R&B softening point of the meltable layer is between about 80° C. and about 100° C.

14. The method of claim 11, wherein applying force comprises applying shear, peel or tensile load.

15. The method of claim 11, further comprising removing adhesive layer residue from at least one of the substrates.

16. The method of claim 11, wherein the meltable layer at melt temperature fails a static shear test in less than 100 minutes measured with a 1.56 cm² tape sample attached between two substrates and loaded with 1 kg weight.

17. The method of claim 11, further comprising a second adhesive layer and a second meltable layer.

18. The method of claim 17, further comprising a film layer.
